(19) United States
(12) Patent Application Publication
(10) Pub. No.: US 2016/0253623 A1
(43) Pub. Date: Sep. 1, 2016

(54) SYSTEM AND METHOD FOR CREATING MANAGING AND VERIFYING POSTAL CORRESPONDENCES

(71) Applicant: Joe Ruiz, Brentwood, CA (US)

(72) Inventor: Joe Ruiz, Brentwood, CA (US)

(21) Appl. No.: 14/952,916

(22) Filed: Nov. 25, 2015

Related U.S. Application Data
(60) Provisional application No. 62/084,548, filed on Nov. 25, 2014.

(51) Int. Cl. G06Q 10/08; G06Q 50/30; H04L 12/58; G06Q 50/26

(52) U.S. Cl. CPC G06Q 10/0833; G06Q 50/26; G06Q 50/30; H04L 51/04; G06Q 2250/50

(57) ABSTRACT

A system for creating, managing and verifying postal correspondences is disclosed. The system includes a plurality of non-transitory storage media information that includes a home page screenshot, a features page screenshot, a CASEMAIL™ screenshot and a pricing screenshot. The method for managing postal correspondences includes postage type selected from the group consisting of standard mail, first-class mail or express mail, choosing to send an e-mail invite to a third party for additional editing and approving one or more letters before submitting for processing, choosing to have e-mail notifications via e-mail or other suitable communication and choosing to log-in into the user's account to track delivery status step that further includes utilizing tracking numbers and other suitable tracking information.

This application claims priority to U.S. Provisional Application No. 62/084,548 filed on Nov. 25, 2014, the entire disclosure of which is incorporated by reference.

### BACKGROUND OF THE INVENTION

The present invention generally relates to a system and method for creating, managing and verifying correspondences. The present invention generally relates to a system and method for managing and verifying electronic correspondences via the postal service. More specifically, the present invention generally relates to a system and method for creating, managing, linking, and verifying electronically delivered and physically delivered postal correspondences delivered through various private and public electronic correspondence services and postal and commercial mail carriers.

Currently there isn't a way to link and group correspondences between two or more parties utilizing the postal or commercial mail service like what may be achieved utilizing an e-mail application or other electronic messaging service. Currently there are web applications that enable a user to upload or create documents online which are then processed into the postal or commercial mail infrastructure where they are then physically delivered. These applications may also provide tracking and delivery information. These applications may also store copies of the correspondences hosted on commercially or privately owned networked servers where the user may easily view and print. However, these existing applications are only one directional and provide no relationship linking or grouping of correspondences between two or more parties based on the context of the correspondences or key identifier between senders and recipients.

Currently there is no way to send, manage and verify electronic correspondences through the United States Postal Service. Currently there are applications and services that enable a user to send, manage and verify electronic correspondences sent through commercial or privately owned services. These applications will also provide tracking and delivery information. These applications may also store copies of the correspondences hosted on commercially or privately owned networked servers where the user may easily view and print. However, these existing applications do not use the United State Postal Service infrastructure to send, deliver, verify and manage electronic correspondences between two or more parties. Nor are the correspondences hosted on United State Postal Service servers.

### SUMMARY OF THE INVENTION

The present invention generally relates to a system and method for creating, managing and verifying correspondences. The present invention generally relates to a system and method for managing and verifying electronic correspondences via the postal service. More specifically, the present invention generally relates to a system and method for creating, managing, linking, and verifying electronically delivered and physically delivered postal correspondences delivered through various private and public electronic correspondence services and postal and commercial mail carriers.

A system for managing postal correspondences includes a server system with a processor system, a communications interface, a communications system, an input system and an output system, the server system having access to a communications network; a memory system with an operating system, a communications module, a web browser module and a managing postal correspondence non-transitory storage media, the managing postal correspondence non-transitory storage media includes a plurality of non-transitory storage media information; and a website displaying the managing postal correspondence non-transitory storage media information.

A method for managing postal correspondences includes the steps of.

It is an object of the present invention to provide a system and method for creating, managing and verifying correspondences that provides a software platform or non-transitory storage media that enables two or more corresponding parties to create, track, manage and share their postal correspondences in a secure neutral environment.

It is an object of the present invention to provide a system and method for creating, managing and verifying correspondences that allows a user to name his postal correspondence in the same manner and all subsequent letters created will be linked to an initial letter.

It is an object of the present invention to provide a system and method for creating, managing and verifying correspondences that when a recipient of the letter responds by postal mail utilizing a software platform or non-transitory storage media, the letter is linked to an original thread with other forms of digital communications also being linked to the original thread.

It is an object of the present invention to provide a system and method for creating, managing and verifying correspondences that interact directly with the United States Postal Service where it will get mail delivery status data for letters created utilizing the software platform or non-transitory storage media.

It is an object of the present invention to provide a system and method for creating, managing and verifying correspondences that may notify all parties, senders and recipients, when trackable mail such as certified mail has been successfully delivered.

It is an object of the present invention to provide a system and method for creating, managing and verifying correspondences that provide automatic reminders to alert users when subsequent letters need to be sent based on a time requirement.

It is an object of the present invention to provide a system and method for creating, managing and verifying correspondences that provides reporting functions that allow a user to see all correspondences by the initial correspondence name.

It is an object of the present invention to provide a system and method for creating, managing and verifying correspondences that provides one click mailing that allows a user to reuse the mailing settings such as return address, envelope type and postage type, from previous mailings to quickly send subsequent mailings.

It is an object of the present invention to provide a system and method for creating, managing and verifying correspondences that provides a sharing function that allows a user to invite others to view their postal correspondences.

It is an object of the present invention to provide a system and method for creating, managing and verifying correspondences that provide the ability to manage, to create, to mail and to manage postal mail on behalf of others.

It is an object of the present invention to provide a system and method for creating, managing and verifying correspondences that when creating a new letter, the user may quickly include previous mailings linked in the thread.

It is an object of the present invention to provide a system and method for creating, managing and verifying correspondences that if a user selects a previous correspondence, the previous recipient's information, contact information, and previous content associated with the correspondence is identified or displayed.

It is an object of the present invention to provide a system and method for creating, managing and verifying correspondences that if a new correspondence is initiated, the user either starts the correspondence by either entering the recipient(s) physical or electronic address information, or by creating or selecting the content to be sent such as a document, an audio, a video, or any structured or unstructured data that may be sent across a network. This content may be selected from various networked sources.

It is an object of the present invention to provide a system and method for creating, managing and verifying correspondences where a new correspondence is given a unique name or identifier either by the user or is auto-generated by the system. This unique name identifier is utilized to keep link and group subsequent mailings associated with each correspondence and to identify this specific mailing within the correspondence thread.

It is an object of the present invention to provide a system and method for creating, managing and verifying correspondences where a user may choose to invite other parties to review, to edit and/or to electronically approve the content of the mailing based on the permissions set by the user.

It is an object of the present invention to provide a system and method for creating, managing and verifying correspondences that includes an e-mail with a link to the content that is sent to the parties where they may either review, edit and/or electronically approve the content of the mailing based on the permissions set by the user. This places the mailing into a holding que until it is ready to be sent.

It is an object of the present invention to provide a system and method for creating, managing and verifying correspondences where a user selects to use the postal service or other government body electronic delivery service and the user selects to utilize an electronic stamp service generated from the postal service or other government body and attached to the content of the electronic correspondence.

It is an object of the present invention to provide a system and method for creating, managing and verifying correspondences where the electronic stamp records all relative information about the correspondence including the senders' and recipients' electronic addresses, the sent date and time, verification of delivery with date and time and the electronic postal correspondence is sent, recorded and stored within the postal service electronic network infrastructure.

It is an object of the present invention to provide a system and method for creating, managing and verifying correspondences where a user pays for postage and fees associated with the correspondence physical delivery, electronic delivery or electronic postal service utilizing a pre-paid account or other payment service.

It is an object of the present invention to provide a system and method for creating, managing and verifying correspondences where the parties of each correspondence who have received authorized log-in credentials keep their correspondence thread intact by accessing the system and selecting the previous correspondence associated with the other parties and repeating as needed.

It is an object of the present invention to provide a system and method for creating, managing and verifying correspondences where the parties of each correspondence whom have received authorized log-in credentials may receive e-mail notifications for delivery failure confirmation if mail is not able to be delivered.

It is an object of the present invention to provide a system and method for creating, managing and verifying correspondences that provide automatic reminders to alert users when subsequent letters need to be sent based on a time requirement.

It is an object of the present invention to provide a system and method for creating, managing and verifying correspondences that interact with other 3^{rd} party's software and systems to access the system's ability to create, mail and manage physical and electronic correspondences.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a system for creating, managing and verifying correspondences, in accordance with one embodiment of the present invention.

FIG. 2A illustrates a block diagram of a client system, in accordance with one embodiment of the present invention.

FIG. 2B illustrates a block diagram of a server system, in accordance with one embodiment of the present invention.

FIG. 3 illustrates a home page screenshot, in accordance with one embodiment of the present invention.

FIG. 4 illustrates a choose a plan to get started screenshot, in accordance with one embodiment of the present invention.

FIG. 5 illustrates a new user registration screenshot, in accordance with one embodiment of the present invention.

FIG. 6 illustrates a payment summary and card details screenshot, in accordance with one embodiment of the present invention.

FIG. 7 illustrates an account log-in screenshot, in accordance with one embodiment of the present invention.

FIG. 8 illustrates a first external content source screenshot, in accordance with one embodiment of the present invention.

FIG. 9 illustrates a second external content source screenshot, in accordance with one embodiment of the present invention.

FIG. 10 illustrates a third external content source screenshot, in accordance with one embodiment of the present invention.

FIG. 11 illustrates a fourth external content source screenshot, in accordance with one embodiment of the present invention.

FIG. 12 illustrates a fifth external content source screenshot, in accordance with one embodiment of the present invention.

FIG. 13 illustrates a mail approval screenshot, in accordance with one embodiment of the present invention.

FIG. 14 illustrates a client approval book screenshot, in accordance with one embodiment of the present invention.

FIG. 15 illustrates a terms and conditions screenshot, in accordance with one embodiment of the present invention.

FIG. 16 illustrates a sixth external content source screenshot, in accordance with one embodiment of the present invention.

FIG. 17 illustrates a seventh external content source screenshot, in accordance with one embodiment of the present invention.

FIG. 18 illustrates a new case mailing screenshot, in accordance with one embodiment of the present invention.

FIG. 19 illustrates a system for creating, managing and verifying postal correspondences in accordance with a first embodiment of the present invention.

FIG. 20 illustrates a system for creating, managing and verifying postal correspondences in accordance with a second embodiment of the present invention.

FIG. 21 illustrates a system for creating, managing and verifying postal correspondences in accordance with a third embodiment of the present invention.

FIG. 22 illustrates a system for creating, managing and verifying postal correspondences in accordance with a fourth embodiment of the present invention.

### DETAILED DESCRIPTION OF THE INVENTION

Various aspects of the illustrative embodiments will be described utilizing terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

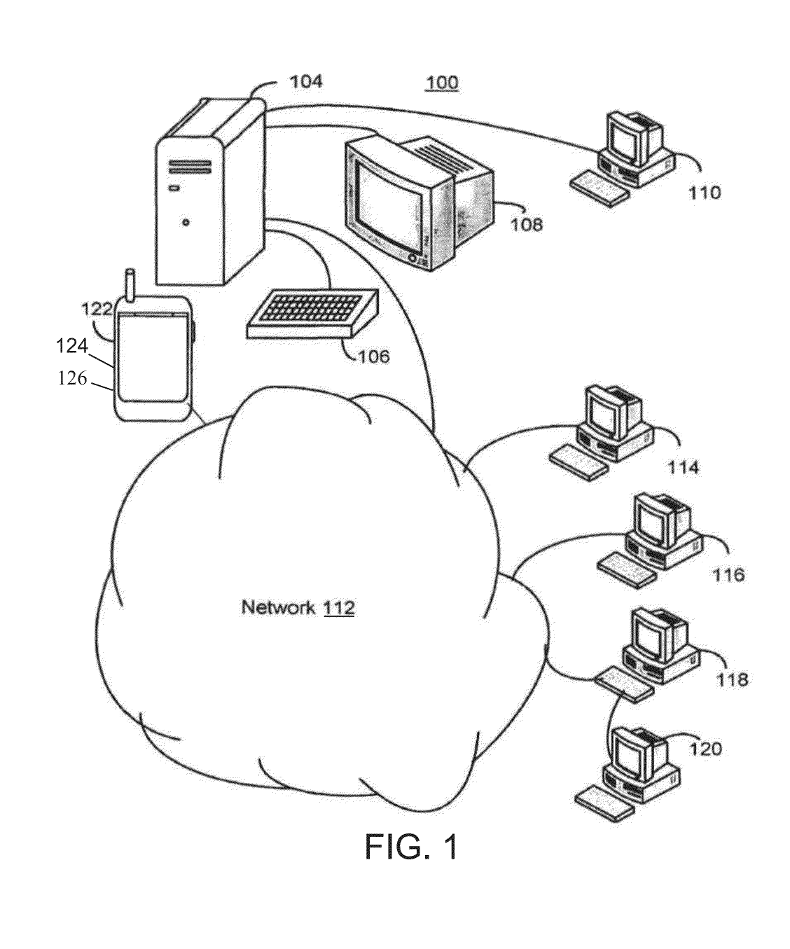

FIG. 1 illustrates a system overview of a system 100 for creating, managing and verifying correspondences. The system 100 may include a server system 104, an input system 106, an output system 108, a plurality of client systems 110, 114, 116, 118 and 120, a communications network 112 and a handheld wireless device 122. In other embodiments, the system 100 may include additional components and/or may not include all of the components listed above.

The server system 104 may include one or more servers. One server system 104 may be the property of the distributor of any related software or non-transitory storage media. In other embodiments, the system 100 may include additional components and/or may not include all of the components listed above.

The input system 106 may be utilized for entering input into the server system 104, and may include any one of, some of, any combination of, or all of a keyboard system, a mouse system, a track ball system, a track pad system, a plurality of buttons on a handheld system, a mobile system, a scanner system, a wireless receiver, a microphone system, a connection to a sound system, and/or a connection and/or an interface system to a computer system, an intranet, and/or the Internet (i.e., Infrared data association or IrDA, universal serial bus or USB).

The output system 108 may be utilized for receiving output from the server system 104, and may include any one of, some of, any combination of or all of a monitor system, a wireless transmitter, a handheld display system, a mobile display system, a printer system, a speaker system, a connection or an interface system to a sound system, an interface system to one or more peripheral devices and/or a connection and/or an interface system to a computer system, an intranet, and/or the Internet.

The system 100 illustrates some of the variations of the manners of connecting to the server system 104, which may be an information providing website (not shown). The server system 104 may be directly connected and/or wirelessly connected to the plurality of client systems 110, 114, 116, 118 and 120 and may be connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals. The client systems 110, 114, 116, 118 and 120 may be any system that an end user may utilize to access the server system 104. For example, the client systems 110, 114, 116, 118 and 120 may be personal computers, workstations, laptop computers, game consoles, handheld network enabled audio/video players, mobile devices and/or any other network appliance.

The client system 120 may access the server system 104 via the combination of the communications network 112 and another system, which in this example may be the client system 118. The client system 120 may be a handheld wireless device 122, such as a mobile phone, tablet or a handheld network-enabled audio/music player, which may also be utilized for accessing network content. The client system 120 may be a cell phone with an operating system or SMARTPHONE® 124 or a tablet with an operating system or IPAD® 126.

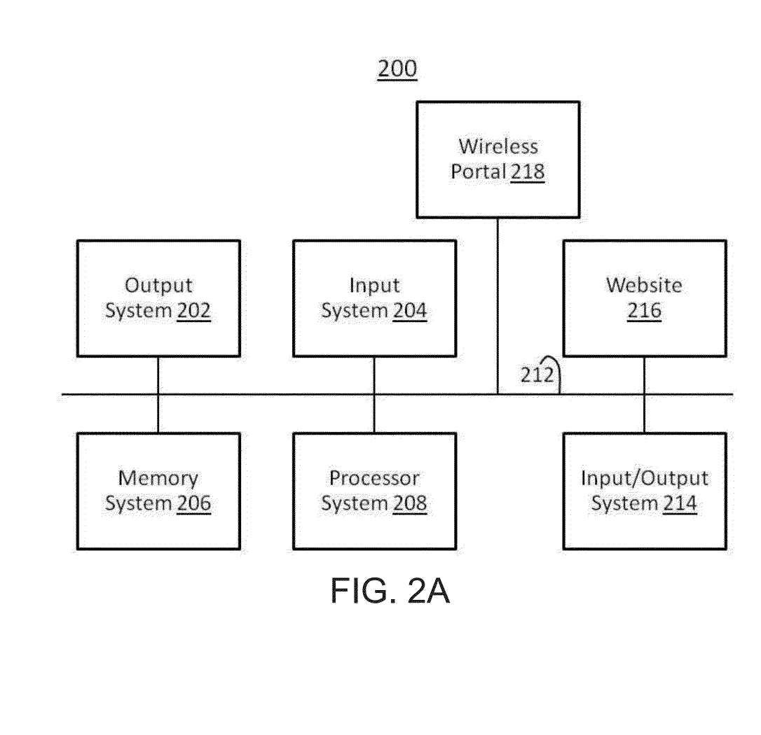

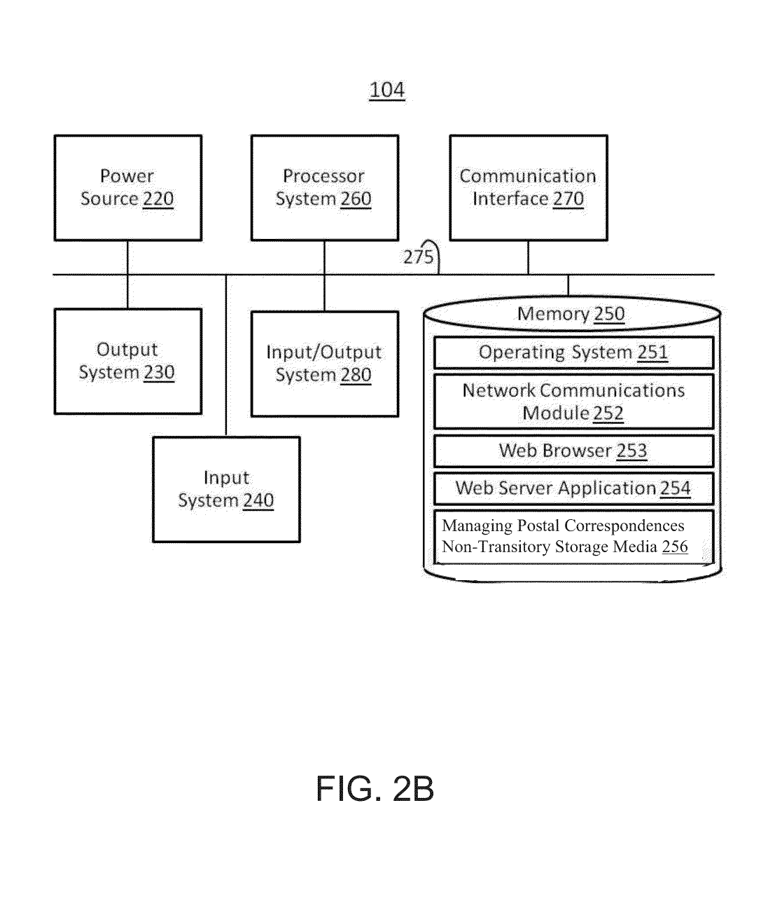

FIG. 2A illustrates a block diagram of a client system 200 that may be utilized as one of the system units for managing postal correspondences. The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122, SMARTPHONE® 124 or IPAD® 126 that may be utilized as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, an intranet, and/or the Internet.

The input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB). The memory system 206 may include, any one of, some of, any combination of or all of a long-term storage system, such as a hard drive, a short term storage system, such as a random access memory; a removable storage system, such as a floppy drive or a removable drive, and/or a flash memory. The memory system 206 may include one or more machine readable mediums that may store a variety of different types of information. The term machine readable medium may be utilized to refer to any medium that may be structurally configured for carrying information in a format that may be readable by a machine. One example of a machine-readable medium may be a computer-readable medium. The memory system 206 may store a non-transitory storage media for managing postal correspondences.

The processor system 208 may include any one of, some of, any combination of, or all of multiple parallel processors, a single processor, a system of processors having one or more central processors and/or one or more specialized processors dedicated to specific tasks. The processor system 208 may implement the programs stored in the memory system 206. The communications system 212 may communicatively link the output system 202, the input system 204, the memory system 206, the processor system 208, and/or the input/output system 214 to each other. The communications system 212 may include any one of, some of, any combination of, or all of one or more electrical cables, fiber optic cables, and/or means of sending signals through air or water (i.e., wireless communications), or the like. Some examples of means of sending signals through air and/or water may include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore may be an output device and accept input when the screens may be pressed by a finger or a stylus. The touch sensitive screens may be sensitive to heat, capacitance and/or pressure. One or more of the input/output devices may be sensitive to a voltage or a current produced by a stylus. The input/output system 214 is optional, and may be utilized in addition to or in place of the output system 202 and/or the input system 204.

The client systems 110, 114, 116, 118, 120 and the handheld wireless device 122 may also be tied into a website 216 or a wireless portal 218 which may also be tied directly into the communications system 212. Any website 216 or wireless portal 218 may also include a non-transitory storage media and a website module (not shown) to maintain, allow access to and run the website as well.

FIG. 2B illustrates a block diagram of a server system 104 that may be utilized for managing postal correspondences. The server system 104 may include a power source 220, an output system 230, an input system 240, a memory system 250, which may store an operating system 251, a communications module 252, a web browser module 253, a web server application 254 and a managing postal correspondences non-transitory storage media 256. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB).

The memory system 250 may include any one of, some of, any combination of, or all of a long term storage system, such as a hard drive; a short term storage system, such as random access memory; or a removable storage system, such as a floppy drive or a removable drive and/or a flash memory. The memory system 250 may include one or more machine readable mediums that may store a variety of different types of information. The term machine readable medium may be utilized to refer to any medium capable of carrying information that may be readable by a machine. One example of a machine-readable medium may be a computer-readable medium such as a non-transitory storage media. The memory system 250 may store one or more machine instructions for managing postal correspondences. The operating system 251 may control all software or non-transitory storage media and hardware of the system 100. The communications module 252 may enable the server system 104 to communicate on the communications network 112. The web browser module 253 may allow for browsing the Internet. The web server application 254 may serve a plurality of web pages to client systems that request the web pages, thereby facilitating browsing on the Internet. The managing postal correspondences non-transitory storage media 256 may reside on the memory system 250.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 may allow the server system 104 to interface with the communications network 112. In this embodiment, the output system 230 may send communications to the communication interface 270. The communications system 275 communicatively links the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water may include systems for transmitting electromagnetic waves such as infrared and/or radio waves and/or systems for sending sound waves.

The input/output system 280 may include devices that have a dual function as the input and output devices. For example, the input/output system 280 may include one or more touch sensitive screens, which display an image and therefore may be an output device and accept input when the screens may be pressed by a finger or a stylus. The touch sensitive screens may be sensitive to heat and/or pressure. One or more of the input/output devices may be sensitive to a voltage or a current produced by a stylus. The input/output system 280 may be optional and may be utilized in addition to or in place of the output system 230 and/or the input system 240.

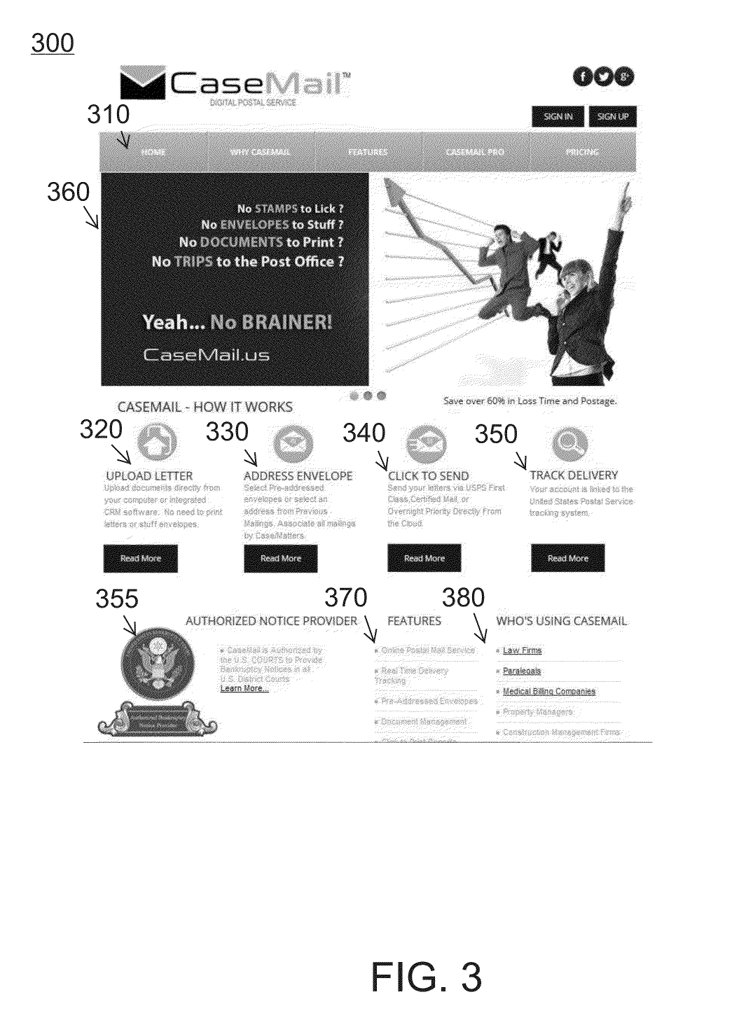

FIG. 3 illustrates a home page screenshot 300, in accordance with one embodiment of the present invention.

The home page screenshot 300 may include a plurality of main links 310, an upload letter link 320, an address envelope link 330, a click to send link 340, a track delivery link 350, an authorized notice provider link 355, a pair advertisement 360, a listing of features 370 and who is using CASEMAIL™ links 380.

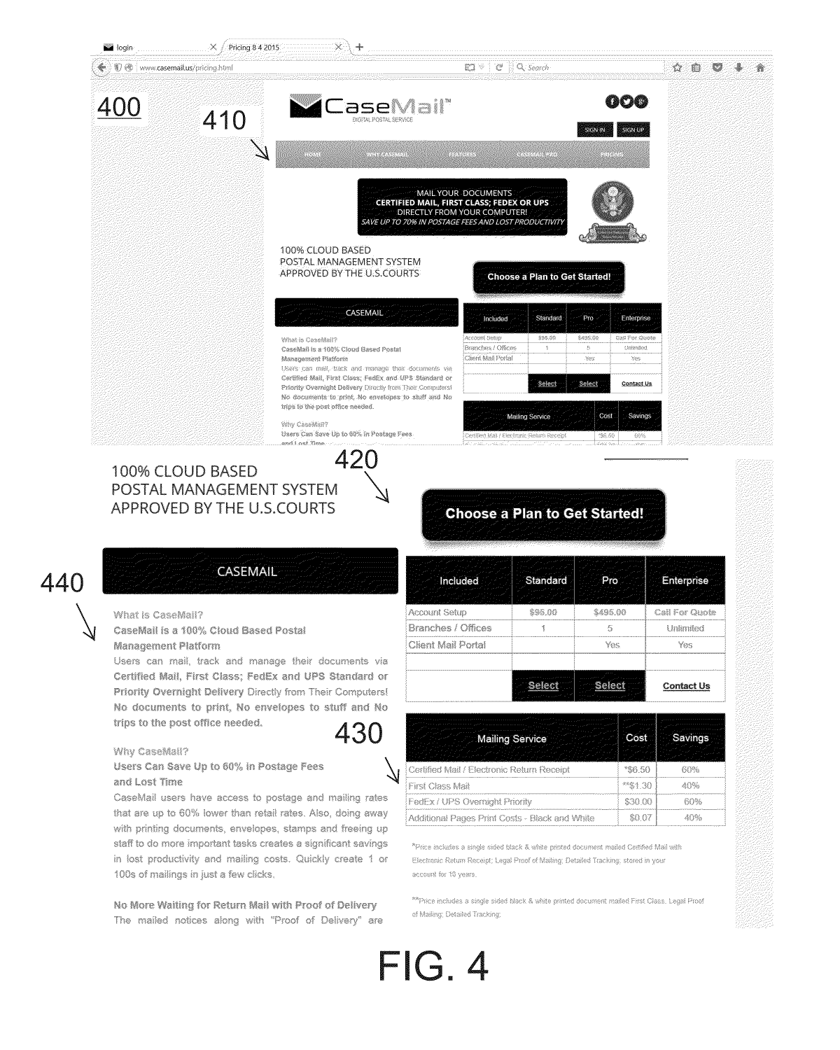

The main links 310 may include a home link, a why a digital postal service or CASEMAIL™ link, a features link, a CASEMAIL™ link and a pricing link. The home link may direct a user to the home page screenshot 300. The why a CASEMAIL™ link may direct a user to additional information about the system (FIG. 1, 100). The features link may direct the user to additional features about the system (FIG. 1, 100). The CASEMAIL™ link may direct the user to a plurality of standard features about the system (FIG. 1, 100). The pricing link may direct the user to the choose a plan to get started screenshot (FIG. 4, 400).

The upload letter link 320 may direct the user to the standard features about the system (FIG. 1, 100). The address envelope link 330 may direct the user to the standard features about the system (FIG. 1, 100). The click to send link 340 may direct the user to the standard features about the system (FIG. 1, 100). The track delivery link 350 may direct the user to the standard features about the system (FIG. 1, 100). The authorized notice provider link may include a description of the system 100 being authorized to provide bankruptcy notices in all U.S. District Courts. The pair of advertisements 360 may include a first advertisement having a question, an answering description and the CASEMAIL™ link. The advertisement 360 may include a second advertisement having a plurality of changing photos with a listing of a CaseMail.com website. The changing photos draw more attention to the second advertisement thereby increasing sales and traffic to the CaseMail.com website. The listing of features 370 may include online certified mailing, real-time delivery tracking, a plurality of pre-addressed envelopes, document management, a plurality of click to print reports and a plurality of dispute resources. The who is using CASEMAIL™ links 380 may provide a listing of CASEMAIL™ users that include law firms, paralegals, medical billing companies, property managers, construction management firms, accountants, tax preparers, auto dealerships and universities.

User either clicks signs in or signs up to create an account. Authorized by the U.S. Bankruptcy Court. This is why I want to leave it open that we may directly manage communications from other sources like the Courts and not just USPS, FedEx and UPS.

FIG. 4 illustrates a choose a plan to get started screenshot 400, in accordance with one embodiment of the present invention.

The choose a plan to get started screenshot 400 may include a certified mail advertisement 410, an account set-up chart 420, a mailing service chart 430 and one or more questions and answers about the system 440.

The certified mail advertisement 410 may indicate to mail documents by Certified Mail, by First Class, by a global provider of transportation, logistics, e-commerce and supply chain management services or FEDEX® directly from a computer to save up to approximately 70% in postage fees and prevent lost productivity. The account set-up chart 420 may include a price quote for a standard system, a pro system and an enterprise system. The account set-up chart 420 may include an account set-up for branches and offices and a client mail portal or other suitable account set-up. The mailing service chart 430 may include mailing service, cost and savings. The mailing service may be for Certified Mail with Electronic Return Receipt, First Class Mail, FEDEX®, freight forwarding service or united parcel service or UPS® Overnight Priority and additional pages print costs for black and white prints. The cost may be in U.S. Dollars or other suitable currency. The savings may be a percent savings in comparing the mailing service cost to the system (FIG. 1, 100) cost. The one or more questions and answers about the system 440 may include questions such as “What is Casemail?” and “Why Casemail?” and a corresponding answer.

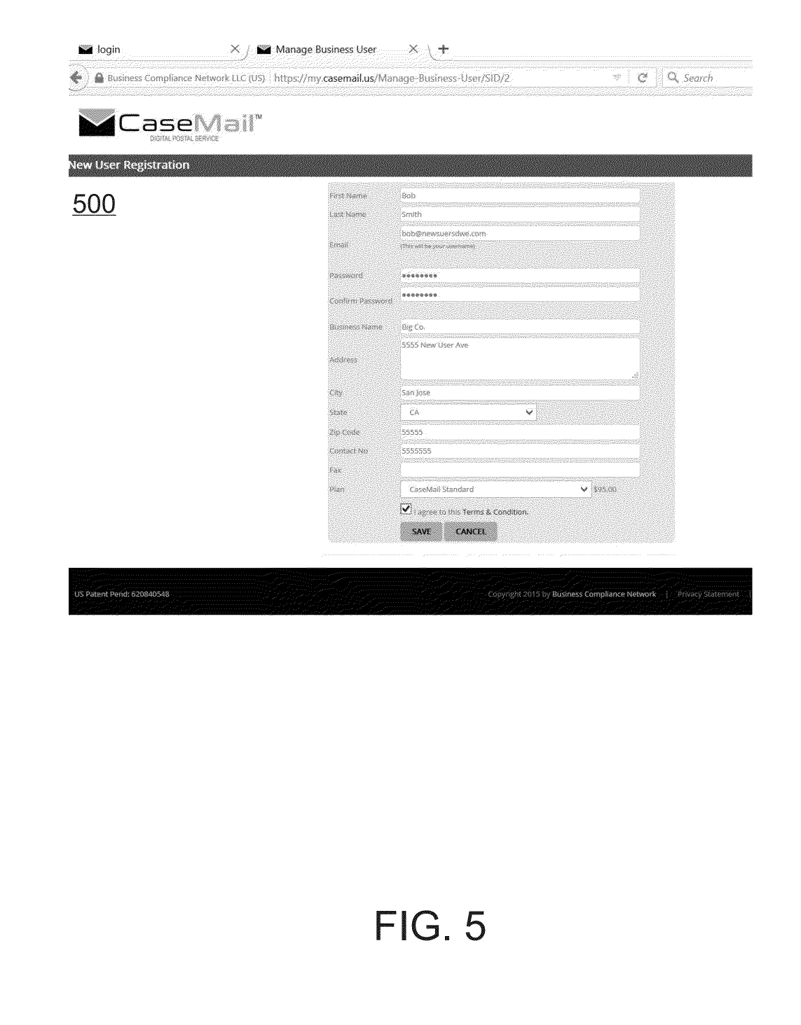

FIG. 5 illustrates a new user registration screenshot 500, in accordance with one embodiment of the present invention.

The new user registration screenshot 500 may include a new user's first name, a new user's last name, a new user's e-mail address, a new user's password, a new user's confirmed password, a new user's business name, a new user's address, a new user's city, a new user's state, a new user's zip code, a new user's contact phone number, a new user's fax number, a dropdown menu for a new user's plan, a terms and conditions checkbox, a save button and a cancel button.

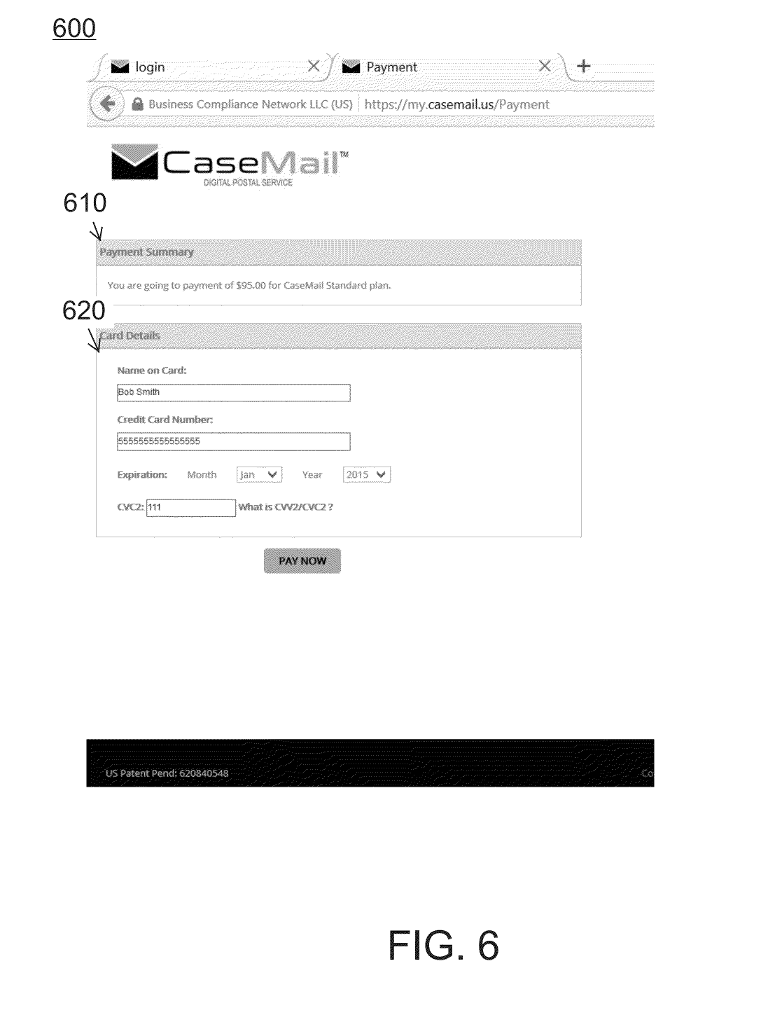

FIG. 6 illustrates a payment summary and card details screenshot 600, in accordance with one embodiment of the present invention.

The payment summary and card details screenshot 600 may include a payment summary section 610 and a card details section 620.

The payment summary section 610 may include a statement of how much a payment is for a selected plan. FIG. 6 illustrates that “You are going to payment of $95.00 for a Casemail Standard Plan”. The card details section 620 may include user's name on the card, user's credit card number, user's expiration month, user's expiration year, a user's CVC2 number and a pay now button.

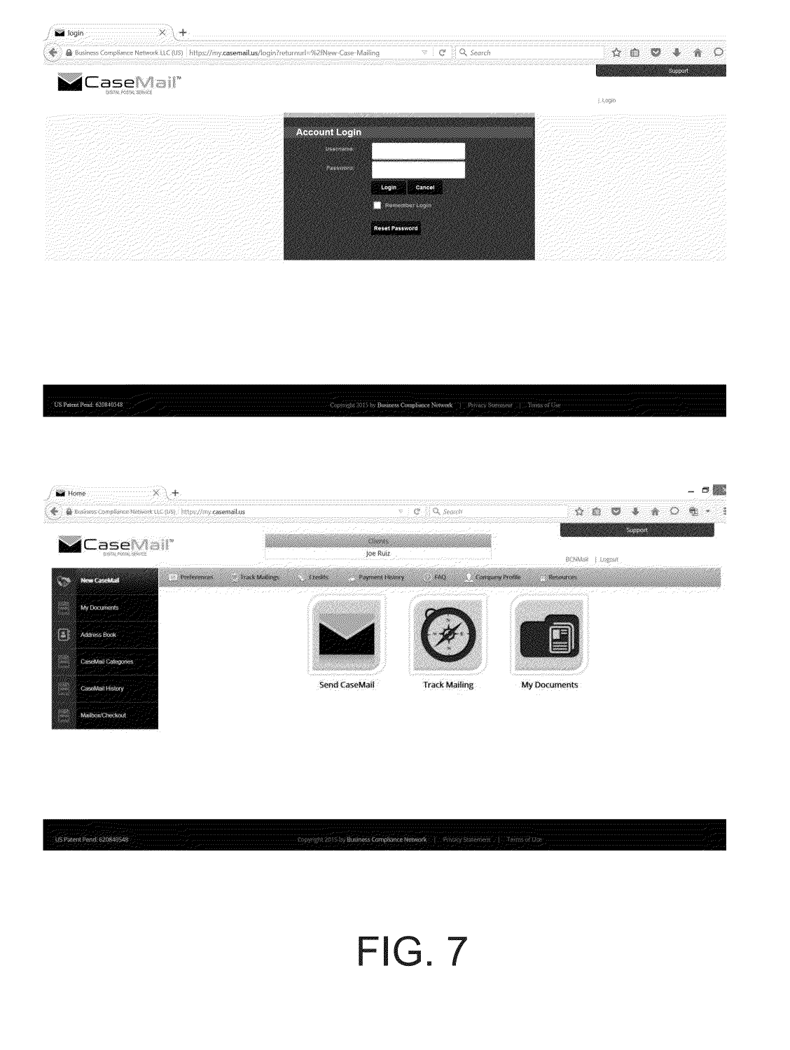

FIG. 7 illustrates an account log-in screenshot 700, in accordance with one embodiment of the present invention.

The account log-in screenshot 700 may include an account log-in section 710 and a plurality of functional buttons section 720.

The account log-in section 710 may include a user name 711, a password 712, a log-in button 713, a cancel button 714, a remember login box 715 and a reset password button 716. The functional buttons section 720 may include a send Casemail button 722, track mailing button 724 and a my documents button 726. The send Casemail button 722 may send any suitable documents via e-mail to a Casemail e-mail address. The track mailing button 724 may track any postal mail sent through the system (FIG. 1, 100). The my documents button 726 may list all of the documents that are created, managed and verified by the system 100.

User chooses an option to start a new correspondence, track a correspondence, or view correspondence history, or view content associated with correspondences.

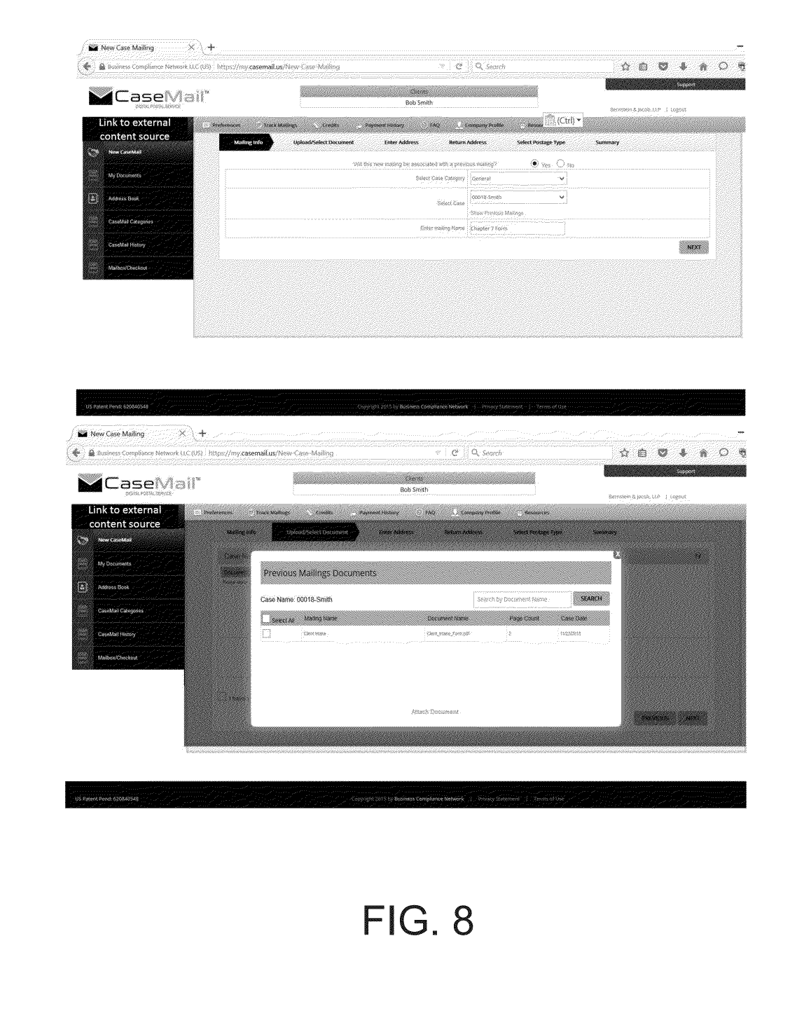

FIG. 8 illustrates a first external content source screenshot 800, in accordance with one embodiment of the present invention.

The first external content source screenshot 800 may a plurality of new case mailing information 810 and previous mailing documents 820.

The new case mailing information 810 may include a will this mailing be associated with a previous mailing yes button 812A, a will this mailing be associated with a previous mailing no button 812B, a select case category dropdown arrow 814, a select case dropdown arrow 816 and a enter mailing name box 818. The will this mailing be associated with a previous mailing yes button 812A may be filled-in to indicate that this mailing will be associated with a previous mailing. The will this mailing be associated with a previous mailing no button 812B may be filled-in to indicate that this mailing will not be associated with a previous mailing. The select case category dropdown arrow 814 may be depressed to select a user case category. The select case dropdown arrow 816 may be depressed to select a user case. The select case category dropdown arrow 814 may include a show previous mailings 814A link to display any previous mailings. The enter mailing name box 818 may be filled-in to describe the mailing name of the user. The new case mailing information 810 may include a next button 819 to forward the user to another screen.

The previous mailing documents 820 may include a case name 822, a search box 824, a plurality of case name information 826 and an attach documents button 828.

The case name 822 may be the user name. FIG. 8 illustrates a case name 00018-Smith. The search box 824 may include a search button 823. The case name information 826 may include a mailing name 826A, a document name 826B, a page count 826C and a case name 826D. The attach documents button 828 may attach one or more documents to be sent by the system (FIG. 1, 100).

User is asked whether this mailing is associated with a previous correspondence. If yes, user is asked to select the previous correspondence from a list of previous correspondences. User is then asked to give this mailing a unique name, example: Client intake message. User may review all past mailings associated with the selected correspondence. User may select previously mailed content to quickly resend. The user then goes to next step.

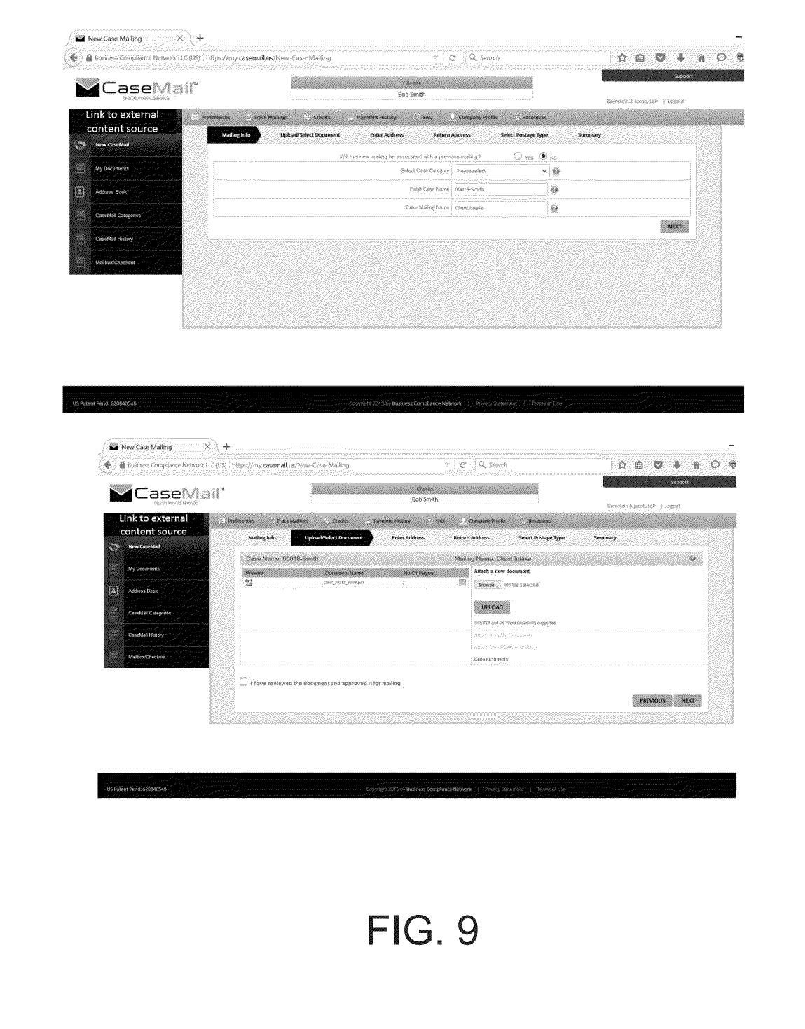

FIG. 9 illustrates a second external content source screenshot 900, in accordance with one embodiment of the present invention.

The second external content source screenshot 900 may include the new case mailing information (FIG. 8, 810) and a plurality of upload and select document information 910.

The upload and select document information 910 may include an uploaded document preview 912, a browse button 914, an upload button 916 and a document approved button 918. The uploaded document preview 912 may include a document icon 912A, a document name 912B and a number of pages notation 912C. The browse button 914 may allow a user to select one or more documents from a user's computer and indicate if no file is selected. The upload button 916 may upload and support only PDF and Microsoft Word documents or other suitable documents. The document approved button 918 may confirm if a user has reviewed the one or more documents and approved them for mailing. The upload and select document information 910 may include a previous button 911 and a next button 913 to move the user forward and behind the second external content source screenshot 900.

If No, user is asked to give this new correspondence a name, example: Bob Smith Case. User is then asked to give this mailing a unique name, example: Client intake message. The user then goes to next step. User selects content to include with mailing. Content may be uploaded from user's connected device or from an external source connected to the system.

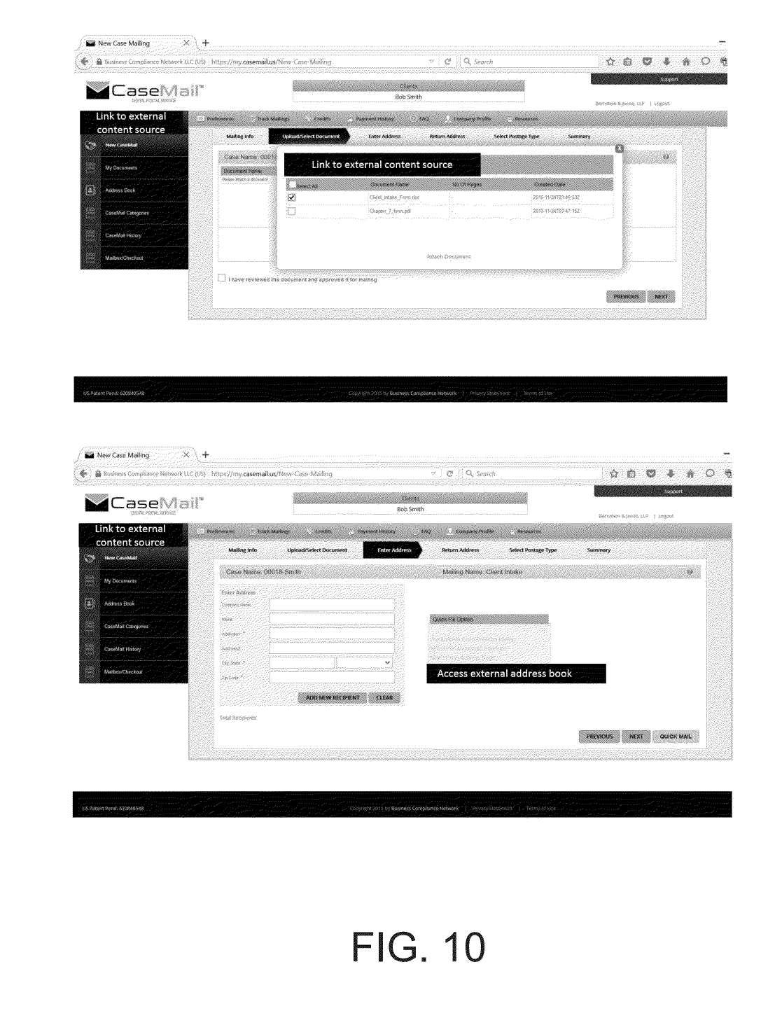

FIG. 10 illustrates a third external content source screenshot 1000, in accordance with one embodiment of the present invention.

The third external content source screenshot 1000 may include an external content source menu 1010 and an access external address book menu 1020.

The external content source menu 1010 may include a selected all box 1012, a document name 1014, a number of pages notation 1016 and a created date 1018. The external content source menu 1010 may also include a previous button 1011 and a next button 1013 to move the user forward and behind the third external content source screenshot 1000.

The access external address book menu 1020 may include a company name 1021, a name 1022, a pair of address boxes 1023, a city box 1023, a state box 1024, a zip code box 1025, an add new recipient button 1026, a clear button 1027, a quick-fil option button 1028, a previous button 1029, a next button 1030, a quick mail button 1031 and a total recipients listing 1032.

Selecting contend from an external source connected to the system. User either inputs recipient's electronic or physical address. User may select contact info from external contact management databases connect to the system.

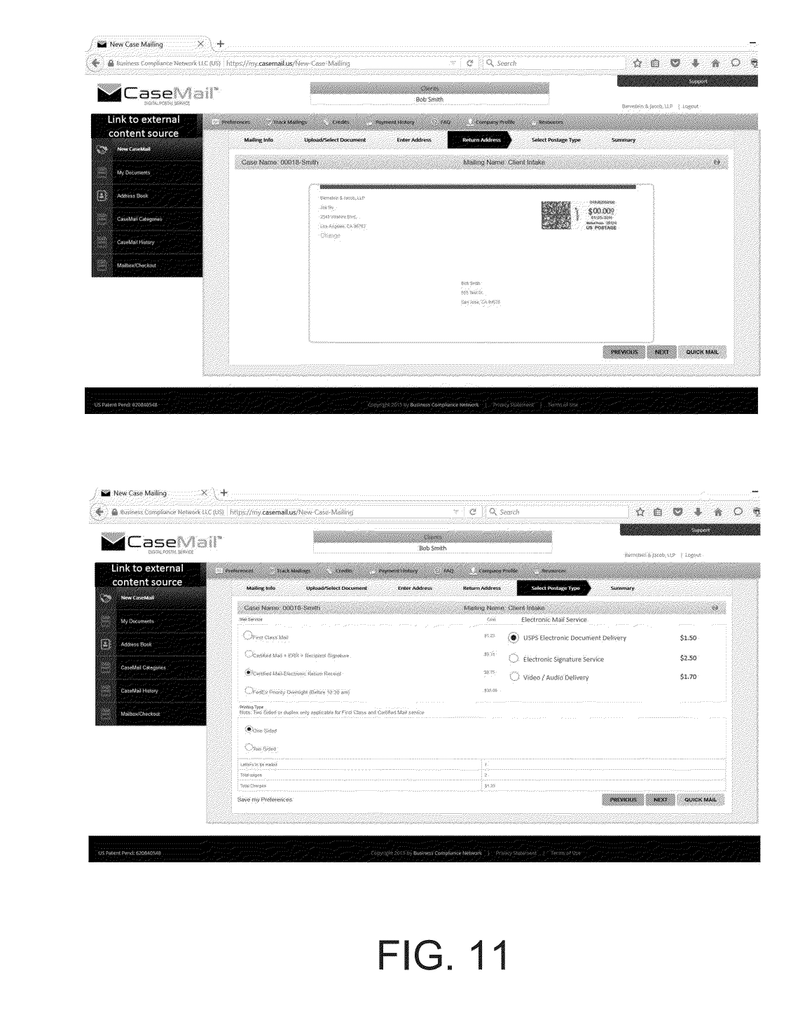

FIG. 11 illustrates a fourth external content source screenshot 1100, in accordance with one embodiment of the present invention.

The fourth external content source screenshot 1100 may include a front envelope portion 1110 and a select a postage type portion 1120.

The front envelope portion 1110 may include an outgoing address 1112, a postage marking 1113 and a return address 1114. The front envelope portion 1110 may include a previous button 1115, a next button 1116 and a quick mail button 1117.

The select a postage type portion 1120 may include a first class mail button 1121, a certified mail with electronic return receipt or ERR button 1122, a certified mail with ERR and recipient signature button 1123, a FedEx priority overnight button 1124, a USPS electronic document delivery button 1125, an electronic signature service button 1126, a video/audio delivery button 1127, a one-sided printing type button 1128, a two-sided printing button 1129, a number of envelope to be mailed listing 1130, a total number of pages listing 1131, a total charges listing 1132, a previous button 1133, a next button 1134 and a quick mail button 1135.

User may review mailing information to assure accuracy. User selects either physical or electronic delivery method with associated postage, mailing and optional features fees. User may choose multiple delivery methods. When user selects a physical delivery service such as USPS, FedEx or UPS, the content of the mailing is electronically sent to the a print center located nearest the recipient for processing into the postal or commercial mail stream where it is physically delivered by the carriers. When user selects an Electronic Delivery method such as secure email, Electronic signature service, or a Video/Audio message the mailing is delivered using the systems own electronic delivery services or 3rd party services connected to the system.

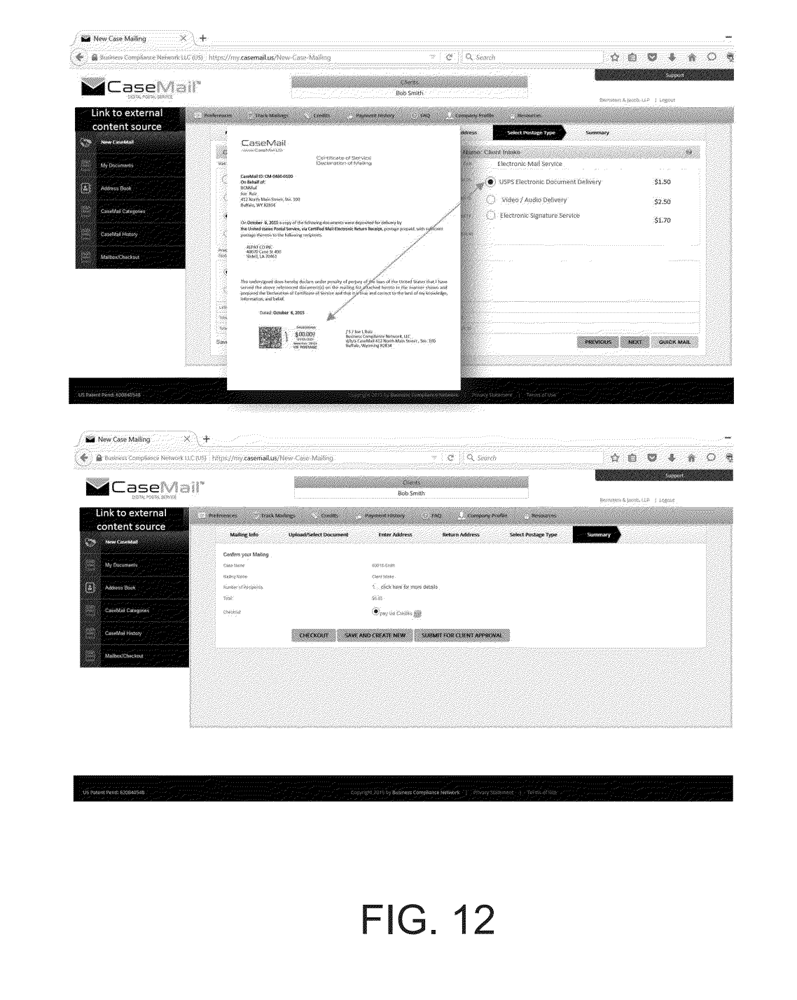

FIG. 12 illustrates a fifth external content source screenshot 1200, in accordance with one embodiment of the present invention.

The fifth external content source screenshot 1200 may include a select postage type page 1210 and a summary page 1220.

The select postage type page 1210 may include a confirmation letter 1212 and a selected postage marking 1214. FIG. 12 illustrates a certificate of service declaration of mailing letter with a USPS electronic document delivery marking.

The summary page 1220 may include a case name 1221, a mailing name 1222, a number of receipts 1223, a total 1224, a pay via clients checkout button 1225, a checkout button 1226, a save and create new button 1227 and a submit for client approval 1228.

User may checkout and complete mailing(s) session. Associated fees are deducted from a user's pre-paid account or by other payment processes. User may click save and create new. This puts the mailing into a que. User then may save the mailing to be sent at a later time and may begin a new mailing session by repeating the above steps. User then may send and pay for all mailings at the same time. User may send an electronic message to authorized parties to review, edit or approve mailing and content before mailing is sent. User may checkout and complete mailing(s) session. Associated fees are deducted from user's pre-paid account or by other payment processes.

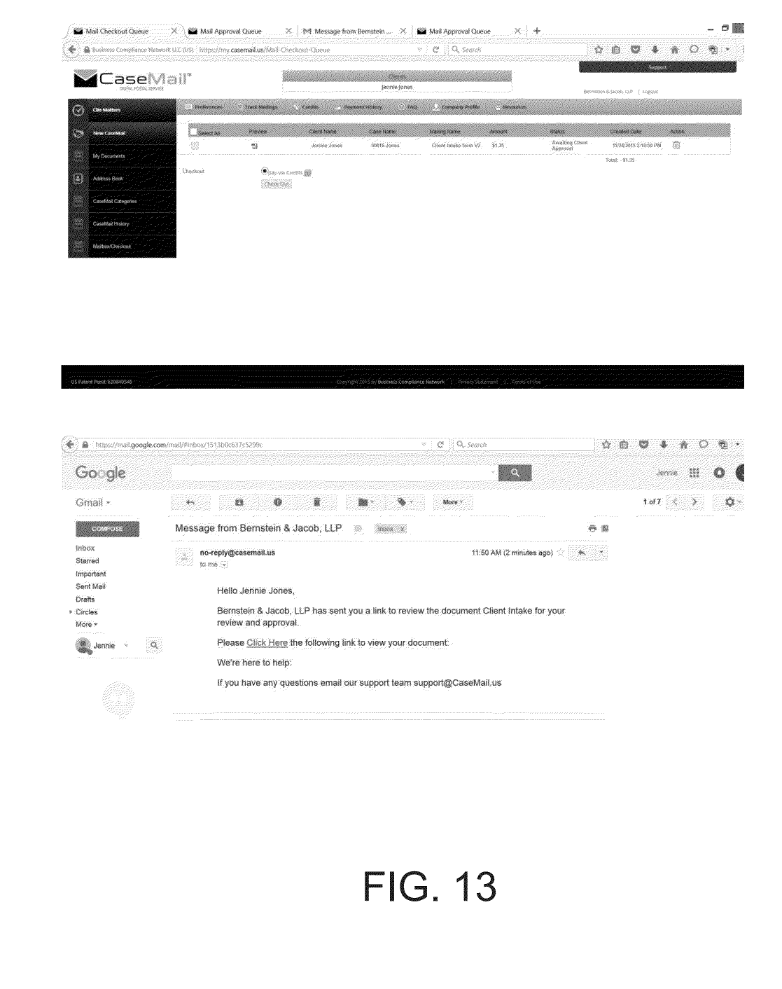

FIG. 13 illustrates a mail approval screenshot 1300, in accordance with one embodiment of the present invention.

The mail approval screenshot 1300 may include a checkout page 1310 and a review and approval e-mail 1320.

The checkout page 1310 may include a select all box 1311, a preview document icon 1312, a client name 1313, a case name 1314, a mailing name 1315, an amount 1316, a status 1317, a created date 1318 and an action icon 1319. The review and approval e-mail 1320 may include a hyperlink 1321 that resides in the review and approval e-mail 1320. The hyperlink 1321 may lead a user directly to a document for review and approval. The checkout page 1310 may also include a pay via credits button 1322, a check out button 1323 and an action icon 1324.

Submit for approval pending approval the mailing is stored in the user's que with the status waiting for approval. The mailing cannot be sent until approved. Submit for Approval Process includes user sends an electronic message to authorized recipient. Message has a secure link to the mailing hosted on a secure system.

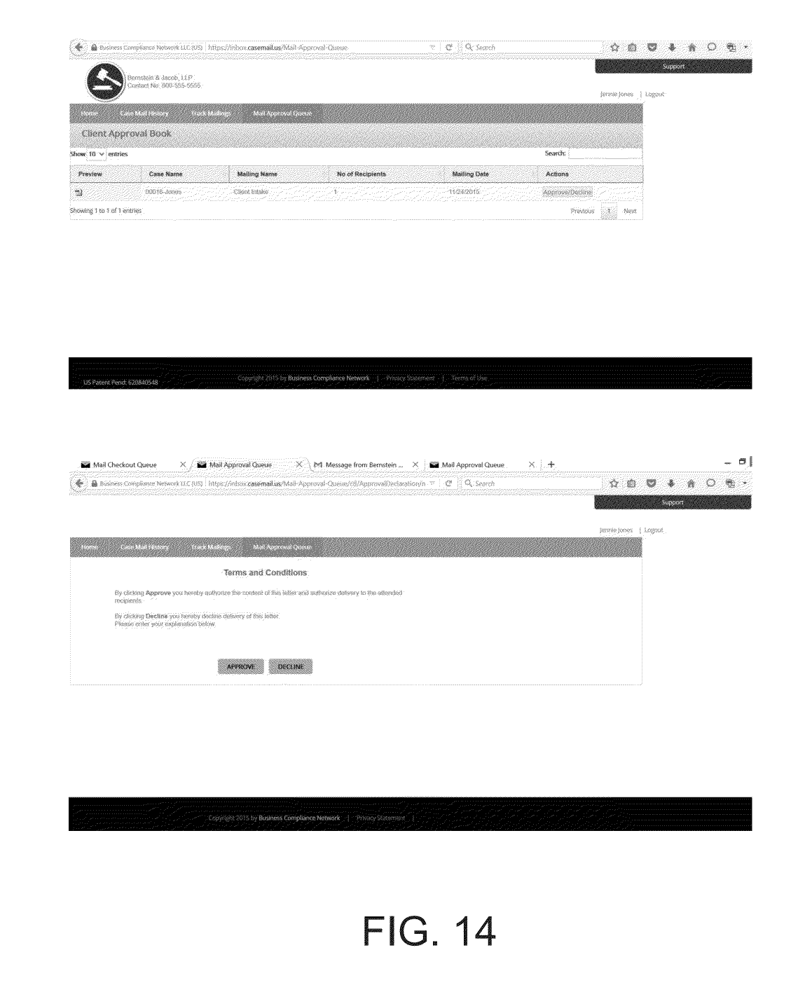

FIG. 14 illustrates a client approval book screenshot 1400, in accordance with one embodiment of the present invention.

The client approval book screenshot 1400 may include a client approval book menu 1410 and a terms and conditions menu 1420.

The client approval book menu 1410 may include a preview 1411, a case name 1412, a mailing name 1413, a number of receipts 1414, a mailing date 1415, an approve or decline action 1416. The terms and conditions menu 1420 may include a plurality of terms and conditions 1421, an approval button 1422 and a decline button 1423.

Recipient's inbox system this is where authorized recipients may view, track, and reply to correspondences. Submit for approval process includes authorized recipient logs into system and sees mailings in their approval que.

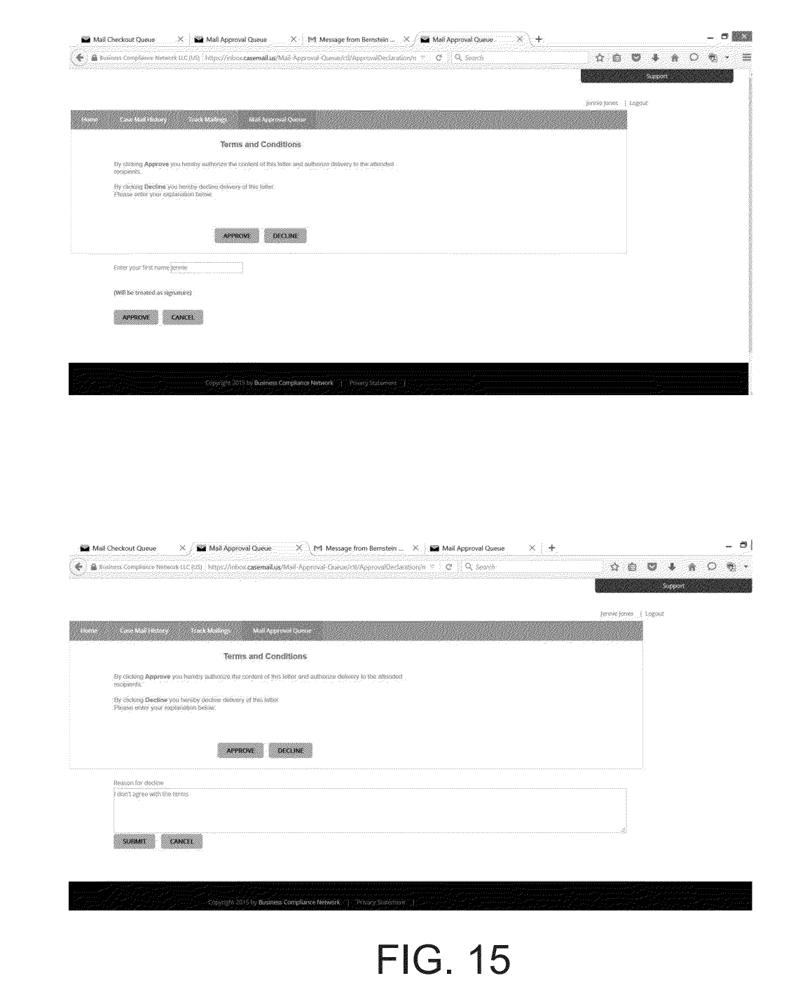

FIG. 15 illustrates a terms and conditions screenshot 1420, in accordance with one embodiment of the present invention.

The terms and conditions screenshot 1420 may include a signature box 1430. The signature box 1430 may include a type-written name 1431 that will be treated as a signature. The signature box 1430 may include an approve button 1432 and a cancel button 1433. The signature box 1430 may include a reason for decline 1432, a submit button 1434 and a cancel button 1435.

Submit for approval process if authorized user approves the mailing they are asked to confirm by simply clicking approve and entering their name or by electronically applying their signature using an electronic signature app. A message is sent to the user that the mailing has been either approved. If the authorized user does not approve of the mailing they are requested to input the reason for the decline.

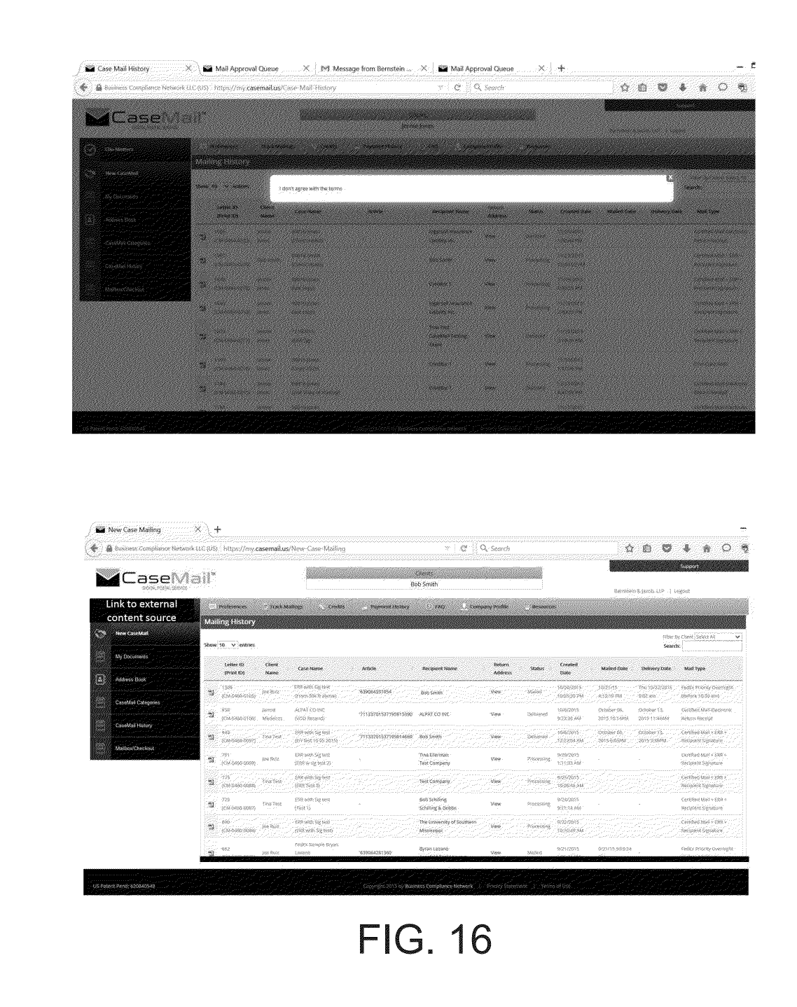

FIG. 16 illustrates a sixth external content source screenshot 1600, in accordance with one embodiment of the present invention.

The sixth external content source screenshot 1600 may include a disagree with terms menu 1610 and a mailing history menu 1620. The disagree with terms menu 1610 may have a disagree with terms menu statement 1612 that resides in a blacked-out background 1614 to make the disagree with terms menu statement 1612 more conspicuous than a standard e-mail. The mailing history menu 1620 may include a letter identification or ID 1622, a client name 1623, a case name 1624, an article 1625, a recipient name 1626, a return address 1627, a mail status 1628, a created date 1629, a mailed date 1630, a delivery date 1631, a mail type 1632 and a search box 1633.

User may select the mailing and view the reason for the decline. Track Mailing Status and Delivery Confirmation may include when user clicks on track mailings a list of all correspondences and their associated mailings will display, each mailing contains relevant information about creation date, mailed dated, mail type, and delivery dated and each mailing has copies of the mailed content.

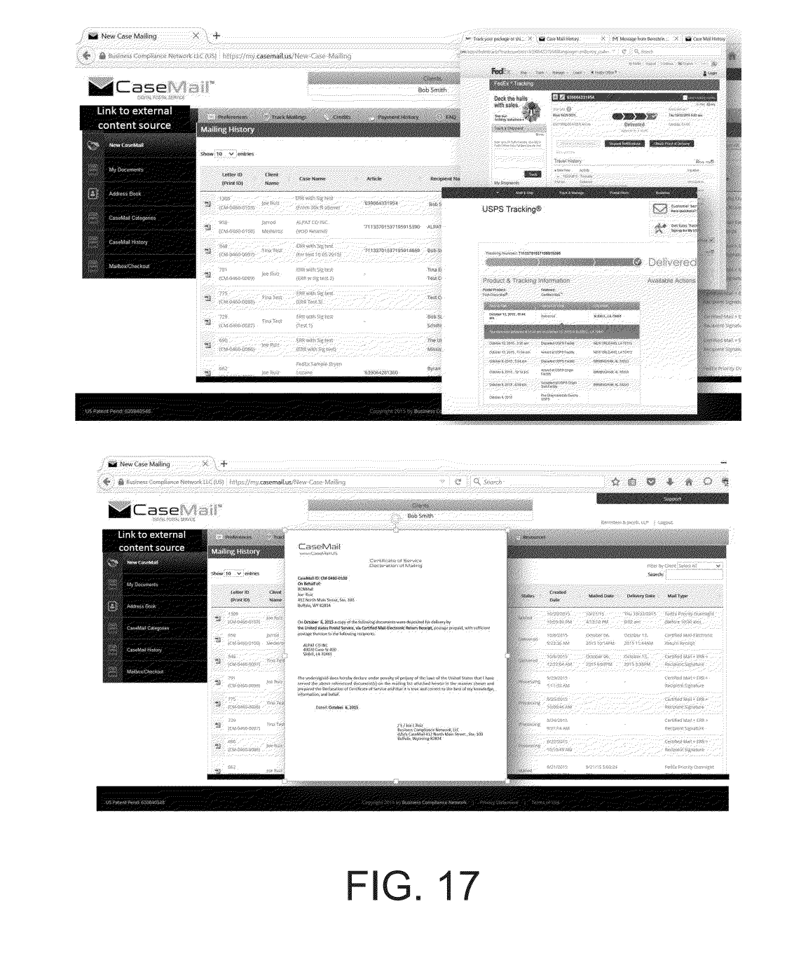

FIG. 17 illustrates a seventh external content source screenshot 1700, in accordance with one embodiment of the present invention.

The seventh external content source screenshot 1700 may include a FEDEX® tracking history 1710, a USPS Tracking® history 1720 and a certificate of service declaration of mailing letter 1730. The FEDEX® tracking history 1710 may include a request notification button 1712, a obtain proof of delivery button 1713 and a delivered message 1714. The USPS Tracking® history 1720 may include a plurality of product and tracking information 1722.

Track mailing status and delivery confirmation includes when user clicks on one of the tracking ids from one of the carries, like FedEx, UPS, or USPS they may see real time tracking from the carriers and system will have the ability to show these carriers tracking info directly from the system. Proof of mailing may include the system generates a “proof of mailing” for every mailing generated by the system. And is attached directly to the content of the mailing. Users may access the proof of mailing by clicking on any past mailing in the mailing history.

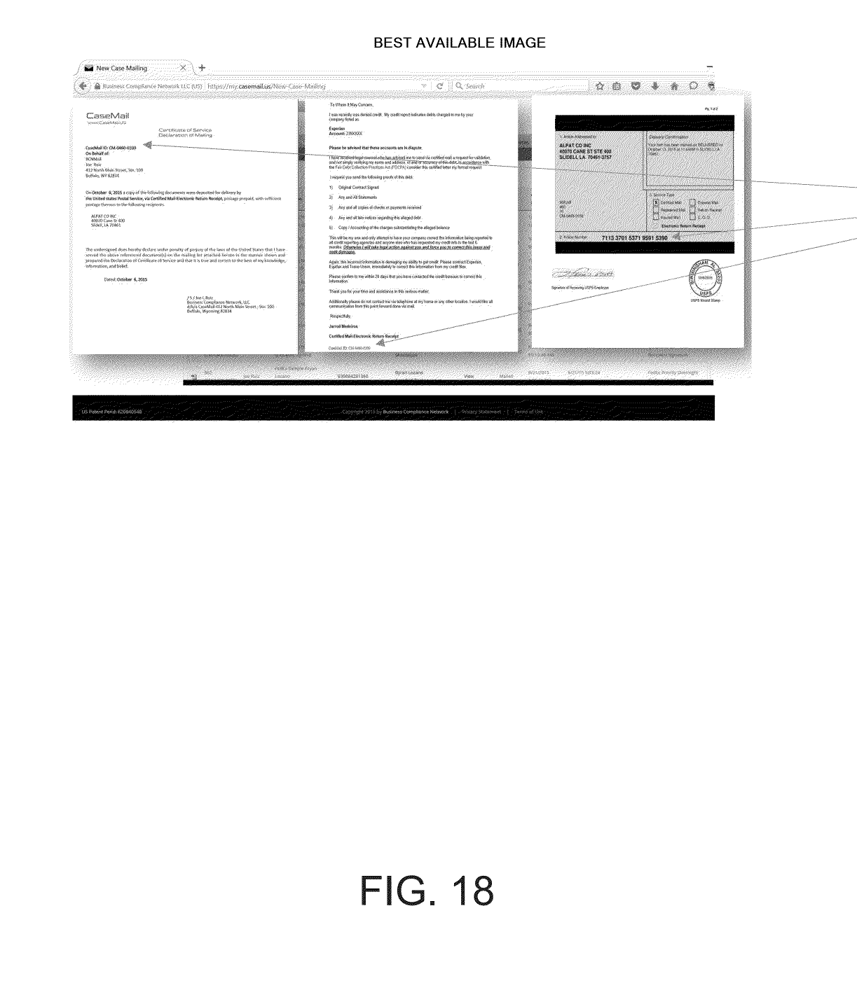

FIG. 18 illustrates a new case mailing screenshot 1800, in accordance with one embodiment of the present invention.

The new case mailing screenshot 1800 may include a certificate of service declaration of mailing letter (FIG. 17, 1730), a dispute letter 1810 and a certified mail return receipt post card 1820.

Along with the proof of mailing if user chose a delivery method that includes proof of delivery, the proof of delivery will be attached to the copy of the mailed content. Every piece of mailed content is marked by the system with a unique ID. This unique ID is what the authorized recipients use to send their replies through the system. This is what groups the mailings to each correspondence between sending and receiving parties.

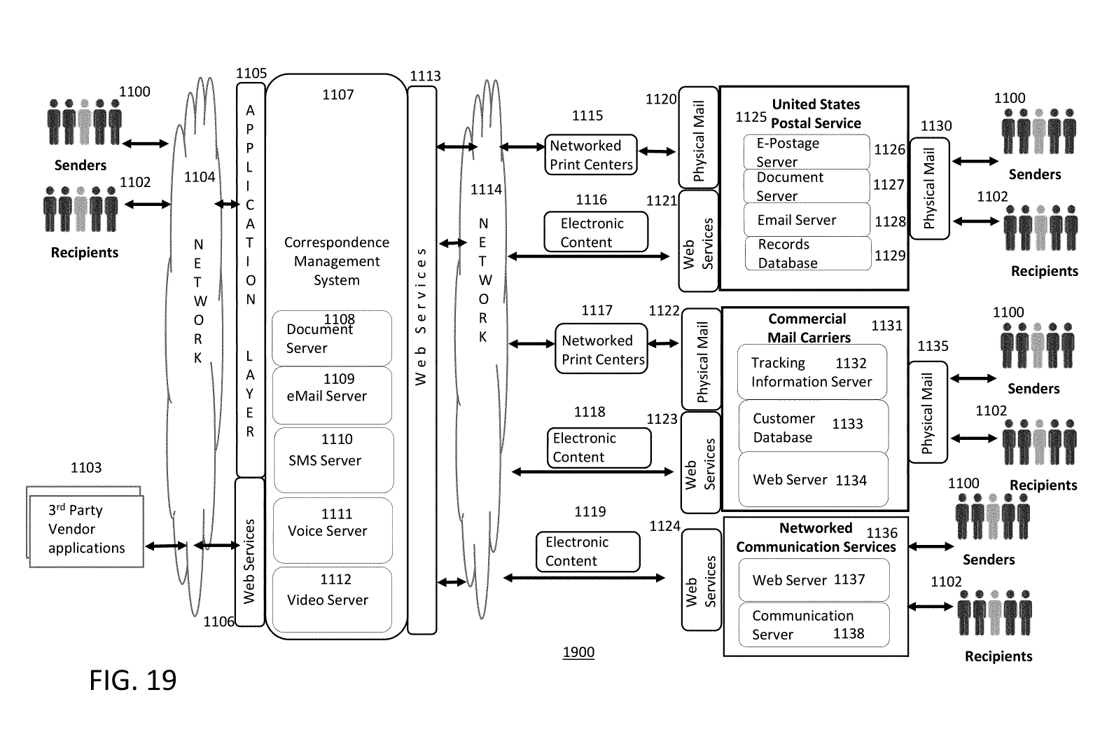

FIG. 19 illustrates a system 1900 for creating, managing and verifying postal correspondences in accordance with a first embodiment of the present invention. The system 1900 comprises senders 1100, recipients 1102, 3rd party vendor applications 1103, a network 1104, an application layer 1105, web services 1106, a correspondence management system 1107, which includes a document server 1108, an email server 1109, an SMS server 1110, a voice server 1111 and a video server 1112, web services 1113, a network 1114, networked print centers 1115, electronic content 1116, networked print centers 1117, electronic content 1118, electronic content 1119, physical mail 1120, web services 1121, physical mail 1122, web services 1123, web services 1124, United States Postal Service 1125, which includes an e-postage server 1126, a document server 1127, an email server 1128 and a records database 1129, commercial mail carriers 1131, which include a tracking information server 1132, a customer database 1133 and a web server 1134, networked communication services 1136, which includes a web server 1137 and a communication server 1138, physical mail 1130 and physical mail 1135.

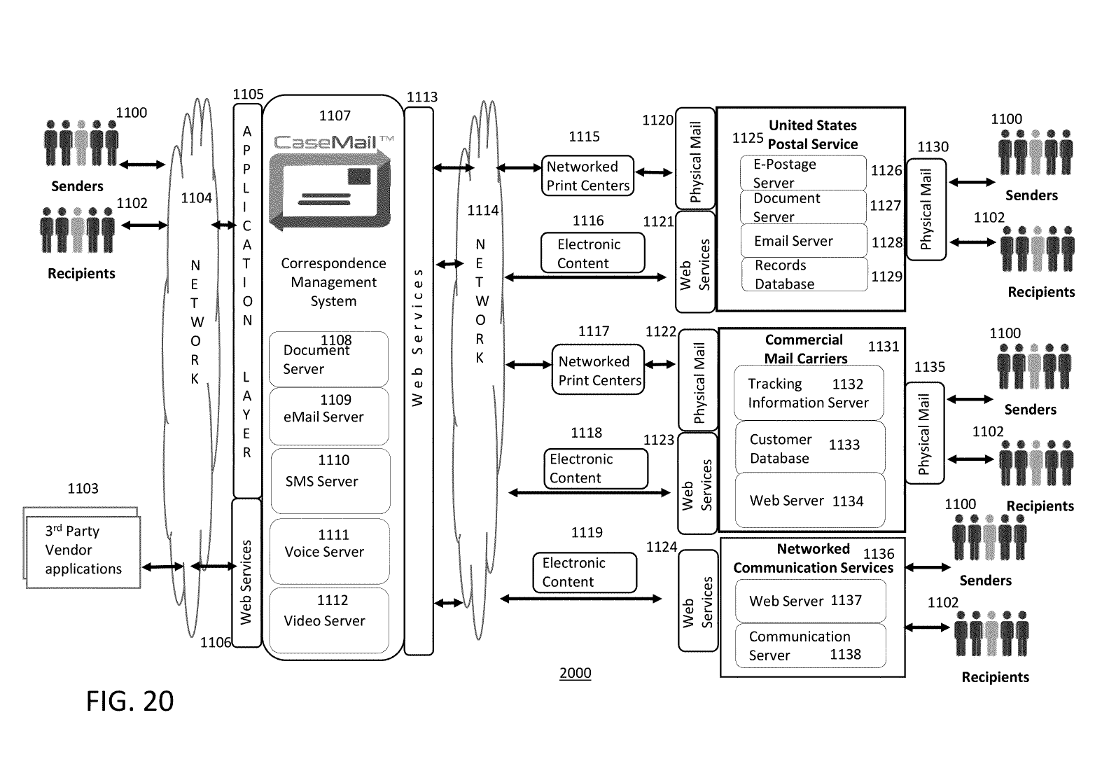

FIG. 20 illustrates a system 2000 for creating, managing and verifying postal correspondences in accordance with a second embodiment of the present invention. In FIG. 20, reference numbers used in FIG. 19 are used to indicate similar elements. The system 2000 comprises senders 1100, recipients 1102, 3rd party vendor applications 1103, a network 1104, an application layer 1105, web services 1106, a CaseMail™ correspondence management system 1107, which includes a document server 1108, an email server 1109, an SMS server 1110, a voice server 1111 and a video server 1112, web services 1113, a network 1114, networked print centers 1115, electronic content 1116, networked print centers 1117, electronic content 1118, electronic content 1119, physical mail 1120, web services 1121, physical mail 1122, web services 1123, web services 1124, United States Postal Service 1125, which includes an e-postage server 1126, a document server 1127, an email server 1128 and a records database 1129, commercial mail carriers 1131, which include a tracking information server 1132, a customer database 1133 and a web server 1134, networked communication services 1136, which includes a web server 1137 and a communication server 1138, physical mail 1130 and physical mail 1135.

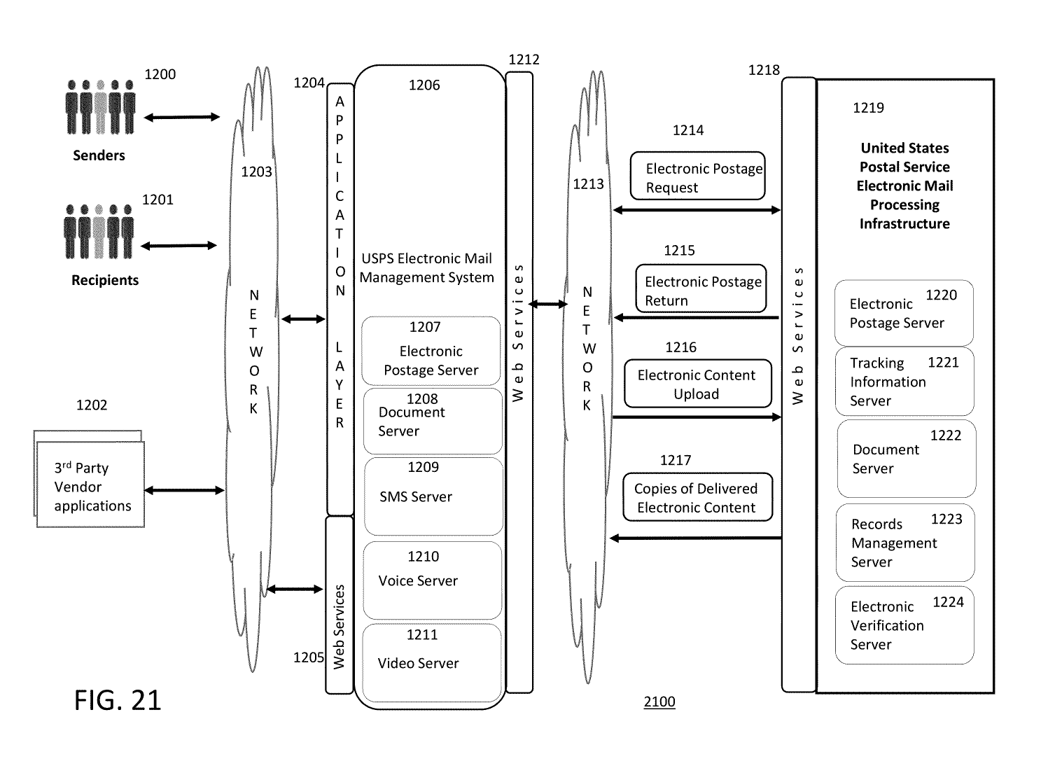

FIG. 21 illustrates a system 2100 for creating, managing and verifying postal correspondences in accordance with a third embodiment of the present invention. The system 2100 comprises senders 1200, recipients 1201, 3rd party vendor applications 1202, a network 1203, an application layer 1204, web services 1205, a USPS electronic mail management system 1206, which includes an electronic postage server 1207, a document server 1208, an SMS server 1209, a voice server 1210 and a video server 1112, web services 1212, a network 1213, electronic postage request 1214, electronic postage return 1215, electronic content upload 1216, copies of delivered electronic content 1217, web services 1218 and United States Postal Service electronic mail processing infrastructure 1219, which includes an electronic postage server 1220, a tracking information server 1221, a document server 1222, a records management server 1223 and an electronic verification server 1224.

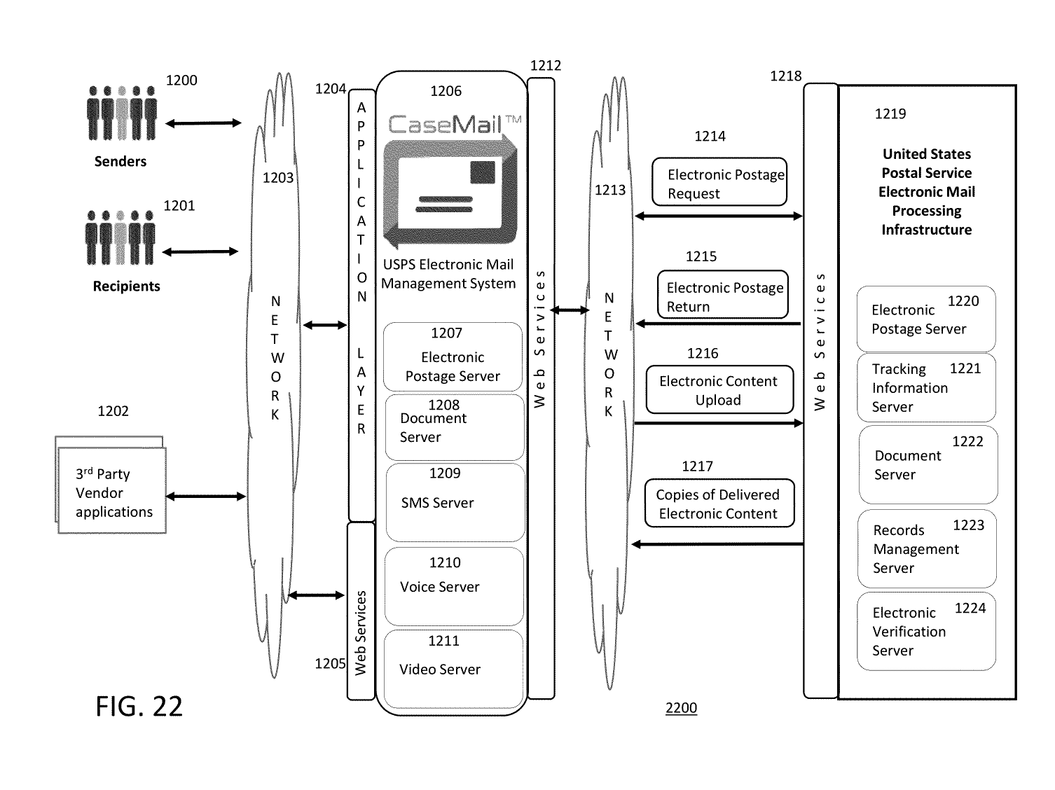

FIG. 22 illustrates a system 2200 for creating, managing and verifying postal correspondences in accordance with a fourth embodiment of the present invention. In FIG. 22, reference numbers used in FIG. 21 are used to indicate similar elements. The system 2200 comprises senders 1200, recipients 1201, 3rd party vendor applications 1202, a network 1203, an application layer 1204, web services 1205, a CaseMail™ USPS electronic mail management system 1206, which includes an electronic postage server 1207, a document server 1208, an SMS server 1209, a voice server 1210 and a video server 1112, web services 1212, a network 1213, electronic postage request 1214, electronic postage return 1215, electronic content upload 1216, copies of delivered electronic content 1217, web services 1218 and United States Postal Service electronic mail processing infrastructure 1219, which includes an electronic postage server 1220, a tracking information server 1221, a document server 1222, a records management server 1223 and an electronic verification server 1224.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

1. A system for creating, managing and verifying postal correspondences, comprising:
a server system with a processor system, a communications interface, a communications system, an input system and an output system, the server system having access to a communications network;
a memory system with an operating system, a communications module, a web browser module and a creating, managing and verifying postal correspondence non-transitory storage media, the creating, managing and verifying postal correspondence non-transitory storage media includes a plurality of non-transitory storage media information that is creating, managing and verifying one or more electronic and physical delivery methods; and
a website displaying the creating, managing and verifying postal correspondence non-transitory storage media information.

2. The system according to claim 1, further comprising a client system having an output system, an input system, a memory system, a processor system and a communications system.

3. The system according to claim 2, wherein the client system is selected from the group consisting of a personal computer, a laptop computer, a tablet computer or a cell phone with an operating system.

4. The system according to claim 3, wherein the client system accesses the server system via the communications network selected from the group consisting of the Internet, one or more local area networks or one or more wide area networks.

5. The system according to claim 2, further comprising an electronic stamp from the USPS that becomes permanently attached to the mailing.

6. The system according to claim 1, wherein the creating, managing and verifying postal correspondence non-transitory storage media screenshot threads together the correspondences together by a unique identifier generated by the system for creating, managing and verifying postal correspondences or a third party.

7. The system according to claim 6, wherein the home page screenshot includes a plurality of main links, an upload letter link, an address envelope link, a click to send link, a track delivery link, one or more advertisements, a listing of features and one or more testimonials.

8. The system according to claim 6, wherein the features page screenshot includes a 100% online postal mail link, a disputemail tracker link, a proof of delivery link, a disputemail calendar, a plurality of dispute reports and one or more dispute advisers.

9. The system according to claim 6, wherein a proof of mailing certificate is generated for each mailing.

10. The system according to claim 9, wherein the proof of mailing certificate includes a proof of delivery that is auto merged with copy of the mailed content inside the user's account.

11. A method for creating, managing and verifying postal correspondences, comprising the steps of:
logging-into a system for postal correspondences;
choosing an option to start a new mailing;
asking a user whether a current mailing is associated with a previous mailing thread;
entering one or more recipients addresses;
automatically entering the user's return address;
selecting a postage type;
choosing to send an e-mail invite to a third party to view;
submitting the approved one or more letters for mail processing;
placing the one or more letters into a processing que;
linking the one or more letters in a database to other mailings;
utilizing the same correspondence name;
choosing to send an e-mail invite to a third party to view and editing and approving the one or more letters before submitting for processing;
processing and placing the one or more letters for delivery;
choosing the postage type and then having one or more servers communicating directly with one or more United States Postal Service servers to provide tracking and delivery status;
choosing to log-in into the user's account to track delivery status; and
choosing to have e-mail notifications sent to them or others once the United States Postal Service confirms delivery of any mail.

12. The method according to claim 11, wherein the postage type selected from the group consisting of standard mail, first-class mail or express mail.

13. The method according to claim 11, wherein the choosing to send step further comprises choosing to send an e-mail invite to a third party for additional editing and approving one or more letters before submitting for processing.

14. The method according to claim 11, wherein the choosing to have e-mail notifications step is via e-mail or other suitable communication.

15. The method according to claim 11, wherein the choosing step choosing to log-in into the user's account to track delivery status step further includes utilizing tracking numbers and other suitable tracking information.

16. A non-transitory computer storage media having instructions stored thereon which, when executed, execute a method comprising the steps of:
logging-into a system for postal correspondences;
choosing an option to start a new mailing;
asking a user whether a current mailing is associated with a previous mailing thread;
entering one or more recipients addresses;
automatically entering the user's return address;
selecting a postage type;
choosing to send an e-mail invite to a third party to view;
submitting the approved one or more letters for mail processing;
placing the one or more letters into a processing que;
linking the one or more letters in a database to other mailings;
utilizing the same correspondence name;
choosing to send an e-mail invite to a third party to view and editing and approving the one or more letters before submitting for processing;
processing and placing the one or more letters for delivery;
choosing the postage type and then having one or more servers communicating directly with one or more United States Postal Service servers to provide tracking and delivery status;
choosing to log-in into the user's account to track delivery status; and
choosing to have e-mail notifications sent to them or others once the United States Postal Service confirms delivery of any mail.

17. The non-transitory computer storage media according to claim 16, wherein the postage type selected from the group consisting of standard mail, first-class mail or express mail.

18. The non-transitory computer storage media according to claim 16, wherein the choosing to send step further comprises choosing to send an e-mail invite to a third party for additional editing and approving one or more letters before submitting for processing.

19. The non-transitory computer storage media according to claim 16, wherein the choosing to have e-mail notifications step is via e-mail or other suitable communication.

20. The non-transitory computer storage media according to claim 16, wherein the choosing step choosing to log-in into the user's account to track delivery status step further includes utilizing tracking numbers and other suitable tracking information.
